(19) United States
(12) Patent Application Publication
(10) Pub. No.: US 2025/0342139 A1
(43) Pub. Date: Nov. 6, 2025

(54) SYSTEMS AND METHODS FOR DATA REQUEST CONVERSION

(71) Applicant: MongoDB, Inc., New York, NY (US)

(72) Inventors: Tom Hollander, Eastwood (AU); Sinha Satyendra Nath, Westmead (AU); Andrew Walker, Bondi Junction (AU); David Hastwell, Baulkham Hills (AU)

(21) Appl. No.: 19/194,782

(22) Filed: Apr. 30, 2025

Related U.S. Application Data
(60) Provisional application No. 63/641,158, filed on May 1, 2024.
(60) Provisional application No. 63/640,978, filed on May 1, 2024.

(51) Int. Cl. G06F 16/21; G06F 16/25

(52) U.S. Cl. CPC G06F 16/212; G06F 16/258

(57) ABSTRACT

Described herein are LLM-assisted techniques for data operation migration between a first schema and a second schema, which may take into account differences between a first dataset under the first schema and a second dataset under the second schema to which the first dataset has been or will be converted. In some embodiments, responsive to receiving a first data request targeting a subset of first data stored in a first database under a first schema, wherein second data is stored in a second database under a second schema and includes a migrated version of the first data, the first data request may be converted into a second data request targeting a subset of the second data that comprises a migrated version of the subset of the first data. Taking into account differences between the schemas may provide migrated data operations that are efficient to run on the destination schema.

### RELATED APPLICATIONS

This application claims the benefit under 35 U.S.C. § 119 (e) of U.S. Provisional Application No. 63/641,158, filed May 1, 2024, under Attorney Docket No.: T2034.70085US00, and entitled “SYSTEMS AND METHODS FOR DATA REQUEST CONVERSION,” which is herein incorporated by reference in its entirety. This application claims the benefit under 35 U.S.C. § 119 (e) of U.S. Provisional Application No. 63/640,978, filed May 1, 2024, under Attorney Docket No.: T2034.70089US00, and entitled “SYSTEMS AND METHODS FOR DISTRIBUTED CATCHALL DATABASE,” which is herein incorporated by reference in its entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

There exist different ways of organizing data in a database, which are often referred to as “schemas.” A common schema used in conventional database is a relational schema. A relational schema stores data in tables having rows and columns. Relational schemas may be strictly enforced due to the need for data to be rigidly structured in order for relational data operations to function on the relational dataset.

Other, more flexible schemas also exist for storing data, such as non-relational schemas. Non-relational schemas permit storage of data in formats other than tables. One example of a flexible schema is a document-based schema, in which data may be stored in documents within collections. Flexible schemas may be configured to function using data operations that do not require the data to be rigidly structured as in relational schemas.

### SUMMARY

The inventors have recognized that migrating data between database schemas is time consuming and tedious, which may discourage the migration of data into schemas that provide for more flexibility and efficiency of data access and/or storage. For example, it is time consuming and tedious to migrate data from a relational database (e.g., stored in tables) to a flexible schema (e.g., non-relational) database (e.g., stored in data structures other than tables, such as documents). One non-limiting example use case of data migration is from a SQL database to a no-SQL (e.g., MongoDB) database.

One issue that the inventors recognized as hindering data migration is that frequently used data operations targeting data under a first schema (e.g., queries, stored processes, and views targeting relational data) are not easily converted for use with a migrated version of the data under a second schema (e.g., unstructured data stored in a flexible schema database). For instance, in addition to the use of different query languages for accessing data stored under another schema, differences in how the same data may be stored in respective schemas may result in differences in how the data may be appropriately accessed in each schema. Thus, while one way to migrate data operations between schemas may be to use existing large language models (LLMs), such as GPT-4, to convert between query languages associated with each schema, merely using an existing LLM in this way is not efficient or even guaranteed to work on a dataset that has been migrated from one schema to another.

The inventors have recognized that, without somehow providing information to an LLM indicating differences between how the pre-migrated dataset is stored under the first schema and how the migrated dataset is stored under the second schema, existing LLMs will not take into account any such differences, including any differences that may improve efficiency of data operations in the second schema. In the above-mentioned example of SQL to noSQL migration, merely feeding SQL queries to an LLM to obtain corresponding no-SQL queries will rely on the LLM's assumption that each table under in the SQL database has been migrated to a corresponding collection in the no-SQL database, which isn't always the case. Moreover, where the LLM that converts data operations from one schema to another assumes that the pre-migrated dataset and the migrated dataset are stored the same way, any improvements to how migrated data is stored under the destination schema are discouraged, because the converted data operations produced by the LLM may not be used on the migrated data if it is stored in a different manner. Moreover, requiring each data operation to be manually adjusted by the user so that an existing LLM may be used would serve to increase the already time-consuming and tedious nature of data migration.

Another complicating factor in using a data operation from a first schema on migrated data stored under a second schema is that data operations intended to be converted may be embedded within general-purpose programming statements, which may complicate the conversion process. For example, an LLM may need to recognize the underlying data operations within the general-purpose programming statements in order to convert the data operations accurately.

To overcome these issues, the inventors developed LLM-assisted techniques for data operation migration between a first schema and a second schema, which may take into account differences between a first dataset under the first schema and a second dataset under the second schema to which the first dataset has been or will be converted. In some embodiments, such techniques may be responsive to receiving a first data request targeting a subset of first data stored in a first database under a first schema, where second data is stored in a second database under a second schema and includes a migrated version of the first data. For example, the first data request may be a query targeting a subset of relational data stored in a relational database, and the second data may be unstructured data in a flexible schema (e.g., non-relational) database to which the subset of relational data has been migrated. In some embodiments, such techniques may include converting the first data request into a second data request targeting a subset of the second data that comprises a migrated version of the subset of the first data. For example, the second data request may retrieve the same results using the migrated version of the first data that the first data request would retrieve on the first data (e.g., prior to migration).

In some embodiments, techniques described herein may use pre-processing (and/or post-processing) to address differences between the first subset of the first data and the second subset of the second data. For example, the first data request may be pre-processed to obtain a modified first data request reflecting differences between the subset of the first data and the subset of the second data, and the modified first data request may be input into an LLM to obtain, using a resulting output from the LLM, the second data request converted from the first data request. By using a modified request that reflects differences between the first data and the second data, an (e.g., existing and available) LLM may be used to convert data operations between schemas so as to preserve (e.g., pre-existing) data operations while taking advantage of differences in how data may be stored under the respective schemas, promoting more efficient storage of migrated data under the destination schema.

Some embodiments provide a method of converting a data request for data under a first schema to a data request for a migrated version of the data under a second schema, the method comprising receiving a first data request targeting a subset of first data stored in a first database under a first schema, wherein second data stored in a second database under a second schema comprises a migrated version of the first data and converting the first data request into a second data request targeting a subset of the second data that comprises a migrated version of the subset of the first data. The converting comprises pre-processing the first data request to obtain a modified first data request reflecting differences between the subset of the first data and the subset of the second data, and inputting the modified first data request into a large language model (LLM) to obtain, using a resulting output from the LLM, the second data request.

In some embodiments, the method further comprises executing the second data request on the subset of the second data stored in the second database.

In some embodiments, the first data stored in the first database comprises relational data, the first data request comprises a query targeting a subset of the relational data, the second database comprises a flexible schema database, and the second data request targets unstructured data stored in the flexible schema database.

In some embodiments, the pre-processing further comprises removing fields from the first data request that are not used in the subset of the second data that is stored in the second database.

In some embodiments, the pre-processing further comprises extracting data operations in a query programming language from within data operations in a general-purpose programming language.

In some embodiments, the pre-processing further comprises identifying a largest data operation of the first data request, determining whether the largest data operation includes multiple query statements, and in response to determining that the largest data operation includes multiple query statements, separating and individually converting the multiple query statements to respective requests for corresponding data in the second database.

In some embodiments, the pre-processing further comprises converting the first data request from a first query programming language of the query to a second programming query language of the modified first data request. In some embodiments, the first query language is a structured query language (SQL) and the second query language is MongoDB query language (MQL).

In some embodiments, the pre-processing further comprises performing a depth-first search in the modified first data request to verify representation of each data operation of the first data request in the modified first data request.

In some embodiments, the pre-processing further comprises replacing names of base data structures under the first schema in the subset of the first data with names of base data structures under the second schema in the second data that comprise the migrated version of the subset of the first data.

In some embodiments, the subset of the first data comprises a first grouping of base-level data structures and a second grouping of base-level data structures under the first schema stored in the first database, the migrated version of the first data comprises a third grouping of base-level data structures under the second schema that comprises a migrated version of the first grouping and the second grouping, and pre-processing the first data request comprises transforming a data operation in the first data request to join the first grouping with the second grouping into a data operation to access the third grouping.

In some embodiments, the first grouping of base-level data structures comprises a first table, the second grouping of base-level data structures comprises a second table, the third grouping of base-level data structures comprises a collection of documents, and the collection comprises first documents corresponding to rows of the first table and further comprises second documents and/or fields in the first documents corresponding to rows of the second table.

In some embodiments, the third grouping comprises a set of base-level data structures corresponding to base-level data structures of the first grouping and further comprises at least one member selected from the group consisting of: another set of base-level data structures corresponding to base-level data structures of the second grouping, and fields within the set of base-level data structures corresponding to base-level data structures of the second grouping.

In some embodiments, the set of base-level data structures comprises documents corresponding to rows of a first table, the another set of base-level data structures comprises documents corresponding to rows of a second table, and the fields within the set of base-level data structures comprise fields within the documents corresponding to rows of the first table.

In some embodiments, the fields comprise an array within a base-level data structure of the set of base-level data structures.

In some embodiments, the array is within a document of the set of base-level data structures.

In some embodiments, the method further comprises post-processing the output from the LLM to obtain the second data request in a query language corresponding to the second schema.

In some embodiments, the post-processing further comprises embedding data operations of the second data request within a general-purpose programming language.

In some embodiments, the pre-processing further comprises determining whether each grouping of base-level data structures in the subset of the first data corresponds to a respective grouping of base-level data structures in the subset of the second data, and when a first grouping of base-level data structures in the subset of the first data does not correspond to a respective grouping of base-level data structures in the subset of the second data, the post-processing further comprises transforming a data operation accessing the respective grouping of base-level data structures in the subset of the second data into a transformed data operation accessing base-level data structures within another grouping of base-level data structures in the subset of the second data corresponding to another respective grouping of base-level data structures in the subset of the first data.

In some embodiments, the transformed data operation accesses an array within a base-level data structure in the another grouping in the subset of the second data, the array corresponding to the first grouping of base-level data structures in the subset of the first data.

In some embodiments, the method further comprises displaying a graphical user interface (GUI) comprising a list of available data requests targeting data stored in the first database, a text view of the first data request selected from the list of data requests, and an option to convert the first data request to the second data request. In some embodiments, receiving the first data request and converting the first data request to the second data request is responsive to selection of the option in the GUI.

In some embodiments, the method further comprises displaying, in the GUI, first results of the first data request and second results of the second data request for user inspection of any differences between the first results and the second results, and providing for re-conversion of the first data request in response to detection of any differences.

In some embodiments, the method further comprises displaying, in the GUI, a list of selectable options for general-purpose programming languages, and responsive to selection of a general-purpose programming language from the list, executing a language-dependent runner corresponding to the general-purpose programming language. In some embodiments, data operations of the second data request are embedded within the general-purpose programming language as at least a portion of post-processing.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one embodiment are discussed herein with reference to the accompanying figures, which are not intended to be drawn to scale. The figures are included to provide illustration and a further understanding of the various aspects and embodiments and are incorporated in and constitute a part of this specification but are not intended as a definition of the limits of the present disclosure. Where technical features in the figures, detailed description or any claim are followed by references signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 illustrates an example process flow for converting a data request for data under a first schema to a data request for a migrated version of the data under a second schema, according to some embodiments

FIG. 2A illustrates a first portion of an example GUI screen that a user may interact with to request conversion of a data request, according to some embodiments.

FIG. 2B illustrates a second portion of an example GUI screen that a user may interact with to request conversion of a data request, according to some embodiments.

FIG. 3 illustrates a text view of an example migrated dataset collection, according to some embodiments.

FIG. 4A illustrates a first portion of an example GUI including first results and second results, according to some embodiments.

FIG. 4B illustrates a second portion of an example GUI including first results and second results, according to some embodiments.

FIG. 5 illustrates examples of data requests and converted data requests that may be obtained using processes described herein, according to some embodiments.

FIG. 6 illustrates a block diagram of an example special-purpose computer system on which various aspects of the present disclosure can be practiced, according to some embodiments.

### DETAILED DESCRIPTION

As described above, the present disclosure provides LLM-assisted techniques for data operation migration from a first schema to a second schema, which techniques may take into account differences between first data under the first schema and second data under the second schema to which the first data has been or will be converted. In some embodiments, data operation conversion may be performed responsive to a data operation conversion request, such as may be received during or in connection with migration of data stored under the first schema to being stored under a second schema.

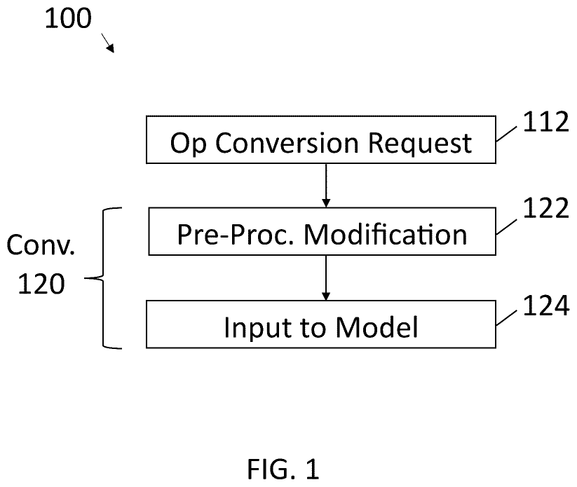

FIG. 1 illustrates an example process flow 100 for converting a data request for data under a first schema to a data request for a migrated version of the data under a second schema, according to some embodiments. As shown in FIG. 1, process flow 100 may include a step 112 of receiving a data operation conversion request and steps 120 of converting a data operation for data under the first schema to a data operation for a migrated version of the data under the second schema.

In some embodiments, process flow 100 may be implemented within a system for migrating data from a first database under a first schema to a second database under a second schema. In some embodiments, the data stored under the first schema may be stored in tables under a relational schema (e.g., SQL) and the migrated version of the data stored under the second schema may be stored in collections of documents under a flexible schema (e.g., MongoDB). In some cases, migrated data may be stored in a different database (e.g., located at a different physical location and/or Internet address) from the pre-migrated data, whereas in other cases, the migrated data may be stored in the same database where the pre-migrated data is or was stored.

The inventors have recognized that data modelling and migration of the dataset are only part of a modernization project, and that updating existing application code presents its own challenges. Without code modernization, data migration projects may fail. Improved migration processes and/or user interface tools may provide targeted assistance in application code modernization efforts that may accompany data migration. Some embodiments target the problem area of converting data requests (e.g., SQL queries and stored procedures), which may be helpful to support within a relational migration application.

In some embodiments, process flow 100 may be executed within a data migration application on a computer system (e.g., operated by a user, such as a database administrator). For instance, process flow 100 may be used to convert Structured Query Language (SQL) code, harvested from stored procedures or entered by the user, into equivalent MongoDB Query Language (MQL) code (optionally wrapped by popular general-purpose programming languages), taking into account the schema transformations defined in the migration project. It should be appreciated that process flow 100 may be alternatively or additionally executed separately from a data migration application, such as in its own application instance, as embodiments described herein are not so limited.

In some embodiments, the data request conversion in process flow 100 may performed so that a data request targeting the data stored under the first schema may be used on the migrated version of the data stored under the second schema. For example, the computer system that performs the data request conversion may store (or otherwise have access to) data requests targeting data stored under the first schema, which may be desired for use on the migrated version of the data. For instance, stored SQL queries may be desired for use on a migrated version of the targeted SQL data under a flexible schema. In some embodiments, the data request conversion performed in process flow 100 may be repeated for each of many stored data requests targeting the data stored under the first schema that are desired to be used on the migrated version of the data stored under the second schema.

In some embodiments, step 112 may include receiving a first data request targeting a subset of first data stored in a first database under a first schema. For example, the first data request may include a query (e.g., a SQL query) that refers to the subset of the first data in a language (e.g., SQL) that is associated with the first schema (e.g., relational or tabular schema). In some cases, the first data request may consist only of a data request, whereas in other cases the first data request may further include general-purpose programming languages (e.g., Java). For instance, general-purpose programming language statements may determine the specific subset of the first data that is targeted (e.g., which rows of a table to query) and/or may be used to analyze and/or format the data returned from the data request for use in a larger program (e.g., which may call the first data request including general-purpose programming language statements), wherein second data stored in a second database under a second schema comprises a migrated version of the first data.

In some embodiments, steps 120 may include converting the first data request into a second data request targeting a subset of the second data that comprises a migrated version of the subset of the first data. For example, the second data request may be designed to target the same subset of data that the first data request targeted, except that the second data is stored under the second schema and may be stored differently as a result. For instance, the subset of the second data may be stored in a manner that is more efficient for the second schema than if it were stored in the same manner as the corresponding subset of the first data stored under the first schema.

As shown in FIG. 1, steps 120 may include a step 122 of pre-processing the first data request to obtain a modified first data request reflecting differences between the subset of the first data and the subset of the second data. For example, the modified first data request may reflect different ways in which the subset of the first data and the subset of the second data may be efficiently stored under the respective schemas. For instance, a subset of the first data may be stored in multiple tables that may be joined as part of the first data request, whereas the subset of the second data may include a collection having data from the multiple tables combined therein, and thus the modified first data request may not need to join multiple collections in the second data.

Also shown in FIG. 1, steps 120 may include inputting the modified first data request into an LLM to obtain, using a resulting output from the LLM, the second data request. For example, the modified first data request may be in a same query language as the first data request (e.g., including a modified SQL query) and the second data request may be in a different query language from the first data request (e.g., including an MQL query). Alternatively or additionally, the modified first data request may be in a different query language from the first data request, in which case the second data request may include a same query language as the modified first data request (e.g., embedded within statements in a general-purpose programming language) and/or the second data request may be in a further different query language, as embodiments described herein are not so limited. In some embodiments, the LLM may be advantageously used to perform language conversion steps that do not rely on the LLM having any understanding of how the subset of the first data is, was, or will be migrated as the subset of the second data.

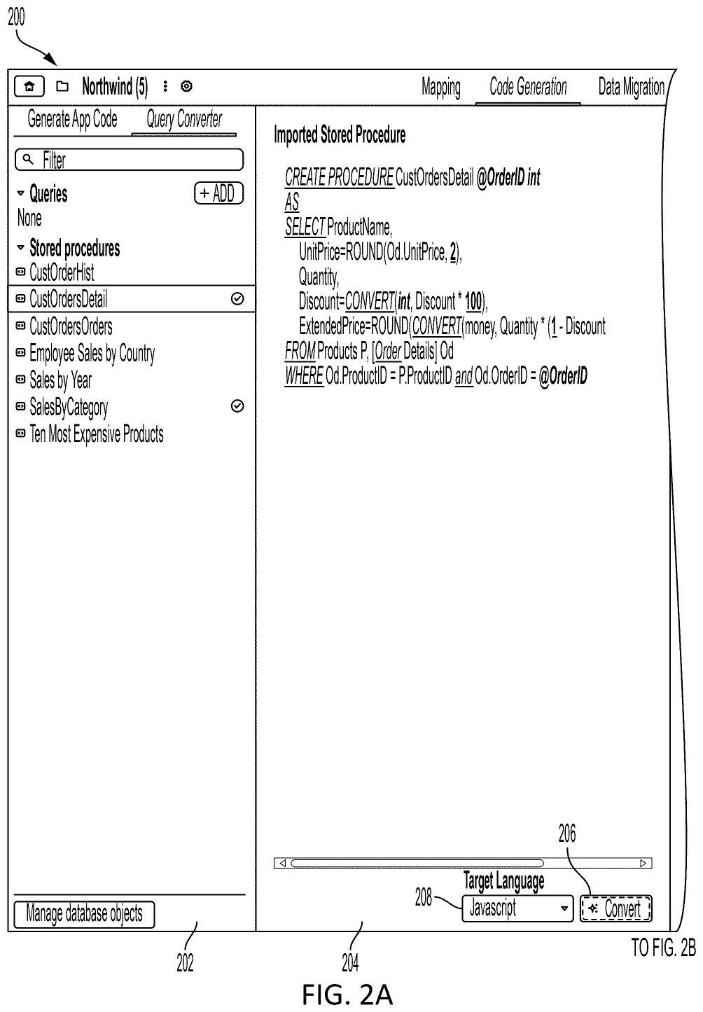

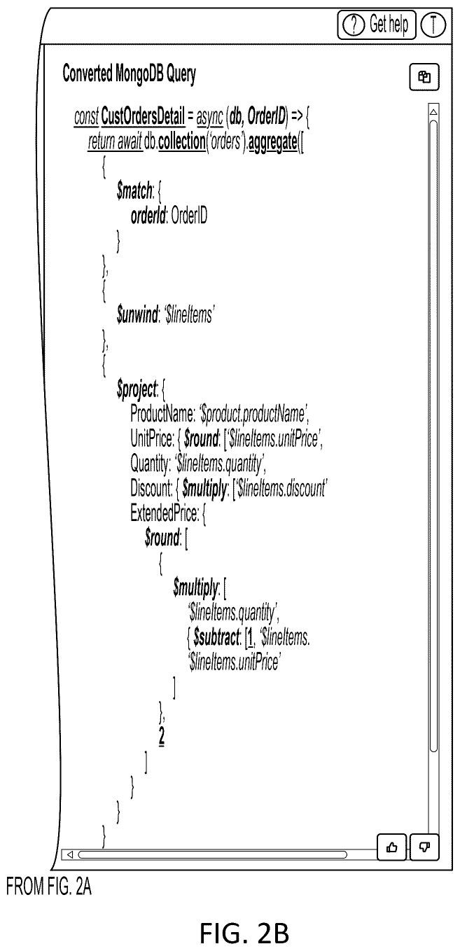

A more detailed implementation example of process flow 100 is described in connection with FIGS. 2A-4B.

FIGS. 2A and 2B illustrate an example GUI screen 200 that a user may interact with to request conversion of a data request, according to some embodiments. The GUI screen 200 shows, in a first column 202, a list of available data requests targeting data stored in the first database. The first column 202 is shown listing the data requests sorted between queries and stored procedures as an example. The GUI screen 200 further shows, in a second column 204, a text view of a first data request, which has been selected from the list of data requests in the first column 202. At the bottom of the second column 204, an option 206 is provided to convert the first data request to a second data request. The option 206 is shown for example, as a “Convert” button in the GUI screen 200. In some embodiments, selection of the option 206 may trigger a data conversion operation request, such as may be received at step 112 in process flow 100.

As shown in second column 204 of the GUI screen 200 in FIG. 2A, the first data request in text view is an example of a SQL Server stored procedure that joins the results from two tables, performs some arithmetic on some of the columns of the tables, and filters the results based on an input parameter. The text of the data request is reproduced below:

```
CREATE PROCEDURE CustOrdersDetail @OrderID int
AS
SELECT ProductName,
  UnitPrice=ROUND(Od.UnitPrice, 2),
  Quantity,
  Discount=CONVERT(int, Discount * 100),
  ExtendedPrice=ROUND(CONVERT(money, Quantity * (1 −
Discount) * Od.UnitPrice), 2)
FROM Products P, [Order Details] Od
WHERE Od.ProductID = P.ProductID and Od.OrderID = @OrderID
```

In the illustrated data request, the Products and Order Details tables are joined in the FROM and WHERE data operations. While a stored procedure is shown in FIG. 2A, other data operations such as queries may be used alternatively or in addition.

As described herein for step 122 in connection with FIG. 1, a first data request may be pre-processed to obtain a modified first data request reflecting differences between the subset of the first data and the subset of the second data, which may improve the efficiency of executing the data request on migrated data. Referring to the above example of a SQL Server stored procedure executing a join on two tables, the stored procedure may be pre-processed to obtain a modified procedure reflecting differences between the SQL database that stores the targeted data and another (e.g., migration destination) database in which the targeted data may be unstructured. For instance, one way of converting the join operation into a query language used to target unstructured data would be convert to a $lookup operation in MongoDB query language (MQL). In MQL, joining two tables may be considered equivalent to joining data from two collections corresponding to the two tables, respectively, which may be achieved by a $lookup operation. On the other hand, however, $lookup operations may be less efficient to conduct on unstructured data than a join operation is to conduct on relational data. To improve efficiency of data access, tables of relational data may be migrated (e.g., at the user's instruction) into a same collection, which may obviate the need for a $lookup operation. Accordingly, when pre-processing a first data request, for example, a join operation may be modified to reflect that the tables being joined in the data request correspond to a same collection in the migrated dataset. In this case, the modified data request may not include a $lookup operation when converted.

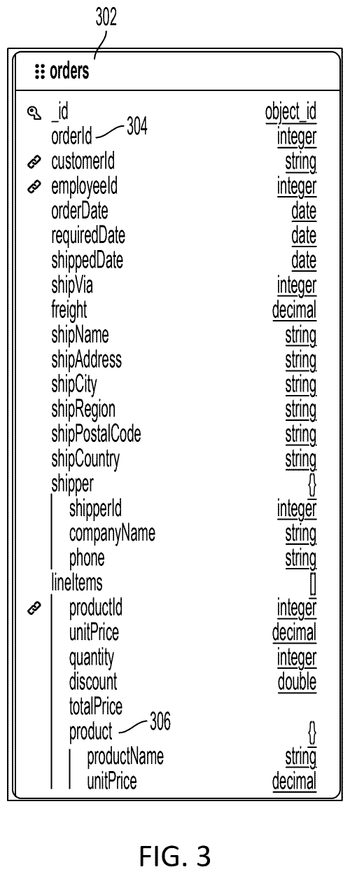

FIG. 3 illustrates a text view of an example migrated dataset collection, according to some embodiments. The illustrated migrated collection is an “orders” collection that may correspond to the “orders,” “order details,” and “products” tables referenced in the above example SQL Server stored procedure. Having migrated these three tables into a single collection, the SQL Server stored procedure may be executed more efficiently by targeting a single collection (e.g., without a $lookup operation).

In some embodiments, pre-processing at step 122 in FIG. 1 may be performed on a data request to reflect differences between the first and second data depending on how the first data was migrated. For example, the subset of the first data may include a first grouping (e.g., table) of base-level data structures (e.g., rows) and a second grouping (e.g., table) of base-level data structures (e.g., rows) under the first schema (e.g., relational) stored in the first database. For instance, in the example of FIGS. 2A-2B, the first grouping may be the “orders” table” and the second grouping may be the “order details” or “products” table. The migrated version of the first data may include a third grouping (e.g., collection) of base-level data structures (e.g., documents) under the second schema (e.g., unstructured) that includes a migrated version of the first grouping and the second grouping. As shown in FIG. 3, for example, the “orders” collection 302 may include migrated versions of the “order details” and “products” tables. In some embodiments, pre-processing the first data request at step 122 in FIG. 1 may include transforming a data operation in the first data request to join the first grouping with the second grouping into a data operation to access the third grouping. For instance, in the example stored procedure of FIG. 2A, a join on the “products” and “order details” tables in the relational data may be transformed into a data operation to access the “orders” collection 302 in the migrated dataset (e.g., directly, without a $lookup operation).

In some embodiments, the third grouping may include a collection of documents including first documents corresponding to rows of one of the tables and further including documents and/or fields in the first documents corresponding to rows of another of the tables. For example, in FIG. 3, the “orders” collection 302 includes documents corresponding to orders that are stored in rows in the “orders” table (using an “orderId” 304 for each row), and further includes fields corresponding to rows in the “products” and “order details” tables. In some cases, a user may determine a migration rule during data migration that selects whether to migrate a given table as a new collection (e.g., resulting in a collection for the respective table), new documents in an existing collection (e.g., consolidating rows of multiple tables in the same collection), or new fields in documents of an existing collection (e.g., as shown above for the additional fields in the “orders” collection from the “order details” and “products” tables). Fields in documents of an existing collection may be implemented directly (e.g., as shown for the fields from the “order details” table in the “orders” collection 302) or using an array within a document of an existing collection (e.g., as shown for the fields from the “products” table shown in the “product” array 306 within the “orders” collection 302 in FIG. 3).

In some embodiments, pre-processing a data request at step 122 in FIG. 1 may include determining whether each grouping of base-level data structures (e.g., table) in the subset of the first data corresponds to a respective grouping of base-level data structures (e.g., collection) in the subset of the second data. For example, there may not be a one-to-one correlation of tables to collections following a data migration, such as for efficiency gains of including data from multiple tables in a single collection in a migrated dataset. In the illustrated example of FIG. 3, there is no one-to-one correlation of “products” and “order details” tables to collections, as the “orders” collection contains the data from both tables.

In some embodiments, a first grouping of base-level data structures (e.g., first table) in the subset of the first data may not correspond to a respective grouping of base-level data structures in the subset of the second data (e.g., has no matching collection), and the post-processing may further include transforming a data operation accessing the respective grouping of base-level data structures in the subset of the second data (e.g., the matching collection that does not exist) into a transformed data operation accessing base-level data structures within another grouping of base-level data structures (e.g., a collection into which the corresponding table as been migrated) in the subset of the second data corresponding to another respective grouping of base-level data structures (e.g., to which another table has also been migrated) in the subset of the first data. For instance, in the example of FIG. 3, a data request to access the “products” table may be transformed into a data request to access the “orders” collection 302, which may further correspond to the “orders” table in the relational data. In this case, accessing the “products” table contents in the migrated dataset would include accessing the “product” array 306 within the “orders” collection 302.

In some embodiments, pre-processing a first data request at step 122 in FIG. 1 may include removing fields from the first data request that are not used in the subset of the second data that is stored in the second database (e.g., which is not used to execute the data operations). In some embodiments, the pre-processing may include extracting data operations in a query programming language from within data operations in a general-purpose programming language. For example, the data operations may be embedded within javascript, C #, and/or java. In some cases, the first data request may be scanned for keywords, such as SQL commands, which may be used to identify data operations. In some embodiments, pre-processing may further include identifying a largest data operation of the first data request, determining whether the largest data operation includes multiple query statements, and in response to determining that the largest data operation includes multiple query statements, separating and individually converting the multiple query statements to respective requests for corresponding data in the second database. For example, the data request may be iterated over to extract individual data operations which may be converted into individual resulting data operations, though in other cases multiple data operations may be converted at once, depending on the implementation.

In some embodiments, pre-processing at step 122 in FIG. 1 may further include converting the first data request from a first query programming language of the query (e.g., SQL) to a second programming query language (e.g., MQL) of the modified first data request. For example, this conversion may occur before inputting any data to an LLM, such as to have the LLM convert within MQL.

In some embodiments, pre-processing at step 122 in FIG. 1 may further include verifying representation of each data operation of the first data operation in the modified first data request that is input to the LLM, such as by performing a depth-first search in the modified first data request to verify representation of each data operation of the first data request in the modified first data request.

In some embodiments, pre-processing at step 122 in FIG. 1 may further include replacing names of base data structures under the first schema (e.g., table names) in the subset of the first data with names of base data structures under the second schema (e.g., collection names) in the second data that comprise the migrated version of the subset of the first data. For example, the replacement may take into account whether multiple tables have been migrated into fewer collections. In some cases, a one-to-one correspondence of tables to collections may be assumed absent information provided indicating a migration of multiple tables into fewer collections such as described herein.

In some embodiments, the modified first data request may be input into an LLM at step 124 in FIG. 1 to obtain the second data request using a resulting output from the LLM. Below is example text of a second data request that may be converted from the above first data request using an LLM (e.g., GPT-4):

```
const CustOrdersDetail = async (db, OrderID) => {
  return await db.collection(‘orders’).aggregate([
    {
      $match: {
        orderId: OrderID
      }
    },
    {
      $unwind: ‘$lineItems’
    {
    },
      $project: {
        ProductName: ‘$product.productName’,
        UnitPrice: { $round: [‘$lineItems.unitPrice’, 2] },
        Quantity: ‘$lineItems.quantity’,
        Discount: { $multiply: [‘$lineItems.discount’, 100] },
        ExtendedPrice: {
          $round: [
            {
              $multiply: [
                ‘$lineItems.quantity’,
                { $subtract: [1, ‘$lineItems.discount’] },
                ‘$lineItems.unitPrice’
              ]
            },
            2
          ]
        }
      }
    }
  ]).toArray( );
};
```

In some embodiments, techniques described herein may include post-processing the output from the LLM to obtain the second data request in a query language corresponding to the second schema. For example, the output from the LLM may provide the second data request directly and/or further processing may performed. For instance, post-processing may further include embedding data operations of the second data request within a general-purpose programming language. As shown above in FIG. 2A, a drop-down list 208 may be provided next to the option 206 allowing a user to select a general-purpose programming language in which to embed the second data request, which may be performed in post-processing. In some embodiments, post-processing may include executing a code-dependent runner, responsive to selection of a programming language, that embeds the data operations within the selected programming language.

In some embodiments, post-processing may reflect differences between the subset of the first data and the subset of the second data (e.g., alternatively or in addition to pre-processing as described above). For instance, an output in MQL from an LLM may be processed to replace a data operation accessing a first collection with a data operation accessing a second collection, such as where the contents of a table in the first data to which the first collection corresponds were migrated to the second collection, such as in respective documents in the second collection and/or an array within the second collection.

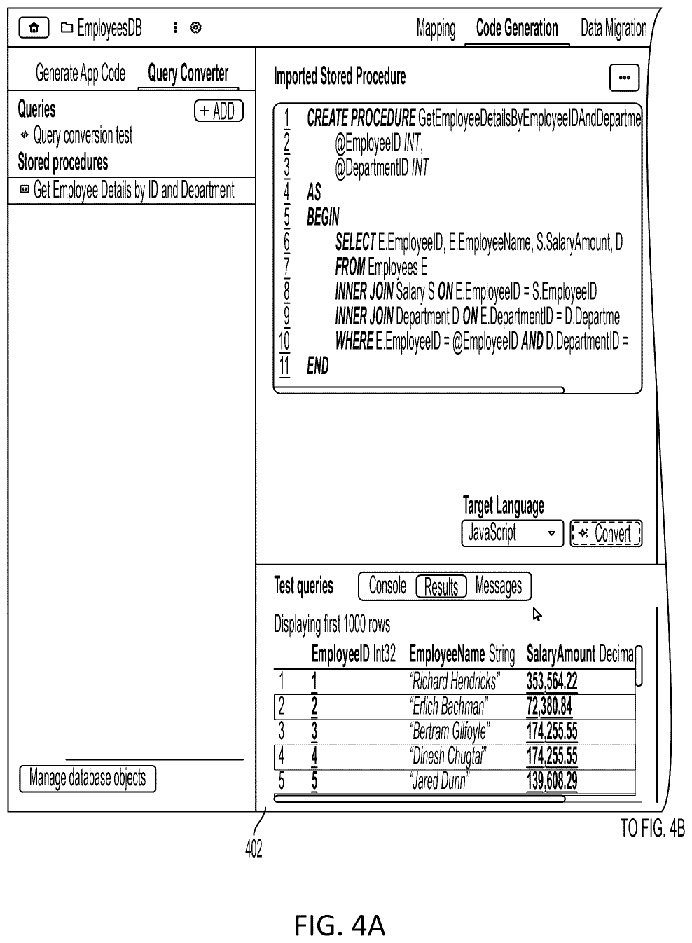

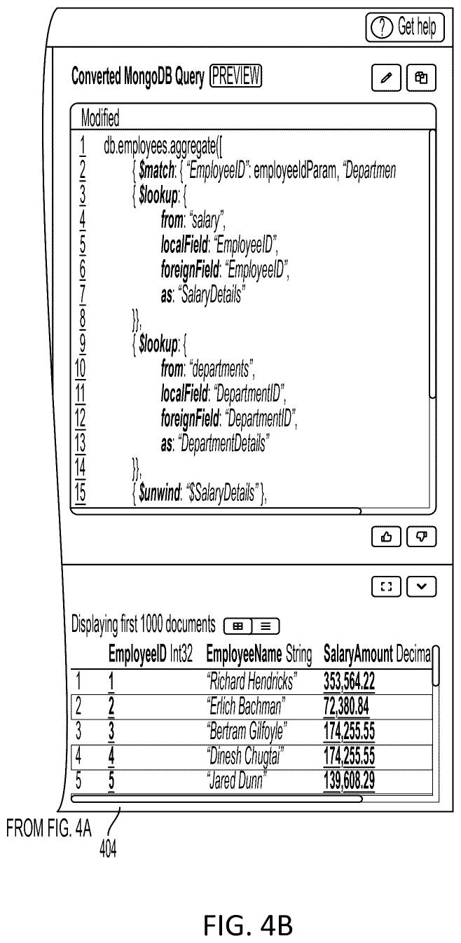

In some embodiments, techniques described herein may include displaying, in the GUI, first results of the first data request and second results of the second data request for user inspection of any differences between the first results and the second results and providing for re-conversion of the first data request in response to detection of any differences. FIGS. 4A-4B show an example GUI including first results and second results, according to some embodiments. In FIG. 4A, the first results 402 are shown in the bottom of the center column of the GUI. In FIG. 4B, the second results 404 are shown in the bottom of the right column of the GUI.

In some embodiments, techniques described herein may further include executing the second data request on the subset of the second data stored in the second database. For example, executing the second data request may be more efficient than version of the first request converted as-is by an LLM due to efficiencies of storage under the second schema.

It should be appreciated that aspects described herein may be used, e.g., in connection with a database migration application (e.g., relational to non-relational migration), to allow users can navigate to a set of features designed to help them modernise their existing data operations.

In some embodiments, a data request to be converted can be one of: an Oracle stored procedure (PL/SQL); a SQL Server stored procedure (T-SQL); and/or an Arbitrary SQL statement from any supported database

In some embodiments, users may input data operations for conversion by: Copying/pasting the data operations into the application GUI; and/or connecting to a relational database and selecting objects containing queries, such as stored procedures or views.

In some embodiments, data operations entered or imported by the user may be saved with a database migration project, and/or can be individually edited and deleted.

In some embodiments, users can choose the language (e.g., query and/or general-purpose programming) to which they want to convert the input code. For simple queries converted for use in a MongoDB database, the target language may be MQL. For stored procedures converted for use in a MongoDB database, the target language may be: Java with embedded MQL; C #with embedded MQL; and/or Javascript with embedded MQL.

In some embodiments, a user can convert data requests by: choosing a specific (e.g., imported) data request to convert, and viewing the output in the GUI (e.g., FIGS. 4A-4B) and/or selecting one or more (e.g., imported) data requests and choosing to download the data requests as a .zip file.

In some embodiments, data requests may be converted with consideration of differences between the source data from the first database and the migrated data in the second database, for example the mapping rules defined in the mapping pane. For example, new collection and field names may be used as compared to tables in the relational source data. Embedded mapping rules may be considered. For example, a SQL query containing a join between two tables may be converted to a find ( ) SQL query if the relevant tables were combined into a single collection in the migrated dataset via an embedded mapping. For instance, a collection may be created with documents corresponding to rows in the first table, and rows from the second table may be added as new documents to the collection, as fields in existing documents (e.g., from the first table) in the collection, and/or as an array within the collection.

In some embodiments, data operation conversion may be instrumented with telemetry to permit monitoring of usage. Telemetry may be automated, and/or users can choose to explicitly send a “thumbs up” or “thumbs down” response along with comments on the quality of the conversion output from the model and/or subsequent post-processing.

In some embodiments, code artefacts beyond individual queries or stored procedures may be alternatively or additionally converted. For example, a complete application in some cases may be converted. In another example, components of the application may be selected by the user for conversion. Users may still determine the overall architecture of the migrated application.

In some embodiments, queries may be obtained for conversion by scanning source code files. In some embodiments, MySQL or Postgres stored procedures may be converted. These types of stored procedures may be supported as an alternative or in addition to Oracle and SQL Server in some examples.

In some embodiments, conversion may be available to users outside of the context of a relational to non-relational migration application. For example, conversion of data requests may be accessible via a web portal and/or API exposed for use over the Internet. Data requests and/or a description of a source database and/or a database migration scheme may be input and converted data requests may be obtained as an output.

In some embodiments, verifications of the converted code (e.g., that it returns identical results to those provided by the original data request) may be performed. In some cases, further user input may be requested for some data requests, (e.g., which may not convert in usable form otherwise).

In some embodiments, the conversion pipeline may involve a preprocessing step, followed by one or more conversion steps depending on whether there were any embedded queries in general-purpose processing language. Some embodiments may make three round trips to the LLM. Alternatively or additionally, the input (e.g., SQL) may be pre-processed (e.g., to rename table and column names to the migrated dataset), such as using Regex. In one example, given a table or column name which may be converted for use on the migrated dataset, one can use the following optional restrictions: (1) the name cannot exist within quotes; (2) the name can only be preceded by a new line, empty space, dot, or any mathematical symbol; and/or (3) the name can only be followed by a new line, empty space, dot or any mathematical symbol.

In some embodiments, data request conversion may be implemented using Python in the backend system design. For example, the entire code base may be written in Python in some cases. This may provide the following advantages: (1) Leverage cutting edge Python libraries to help parse and analyse SQL queries; and (2) Improve developer experience by fast prototyping and testing through tools such as Jupyter notebook. In some embodiments, the latest version of Python (3.12) may be used.

In some embodiments, migrating a data request conversion pipeline to Python may take place over four stages: (1) System prompts; (2) Main prompts; (3) Pipelines; and (4) Lambda scaffolding. In addition to what one may have for the Lambda deployment, one would maintain a REST API deployment to ensure portability to Helix. One will be using FastAPI as the framework for this as it is becoming the de facto option for many production projects given its superior speed and compatibility with type validation and code generation libraries.

In some embodiments, testing for data request conversion may be done manually (e.g., at least initially) where a skinned down version of mappings are handcrafted and used as inputs to the prompting pipeline. Building tests in this manner for an entire testing process may be very time consuming. Alternatively or additionally, seeding test data and iterating through the test data using a test runner may be performed.

The following steps may be scripted to gather test data from a SQL database, for example, first, a SQL database may be imported into a relational to non-relational migration application project. This may be possible through a relational to non-relational migration application but may use calling project creation endpoints to crawl through the schema, using recommended schema mappings and creating a project. A migration job may be run to populate a MongoDB database and the resulting documents may then be exported (e.g., using Mongoexport). The project may also be exported for the test run.

Next, SQL queries may be imported. Databases that already have sprocs and views can all be exported using the existing query conversion import endpoint within the migration application. Alternatively or additionally, if there is a cache of SQL queries, these can be exported per database; the spider dataset is an example of this. These queries may be linked to a certain database, along with the expected aggregation output, as described next.

In some cases, a result output from executing some or all imported SQL queries may be imported: This may include calling the relevant relational database driver to execute the query and collect the results.

The SQL output may be converted to MongoDB aggregation results: Once the SQL results are collected, they can be used to form expected results for the aggregation in the converted query. The results from executing the converted query may be exported to a JSON file. The default result may be a tabular structure such that there will not be any nested entries in an individual JSON object. In some cases, a verification code may be used to handle nested entries.

Next, relevant mappings and fields may be extracted. These may serve as input to the query conversion pipeline. This extraction code may already exists in the migration application as part of the QueryConversionRequestBuilder and may be called in a testing context.

In some embodiments, some or all of the steps listed above may use or extend existing functionality of a relational to non-relational migration application. In some cases, new or alternative endpoints may be used than are used in the migration application (e.g., without data request conversion). To maintain isolation a separate Testing controller may be added alongside existing Project and Schema controllers for managing the above changes. The Testing controller will reuse some existing code but use different endpoints than what is currently used in production. The testing controller may be tested similar to existing endpoint controllers to ensure that the contract between existing RM code and the controller does not break.

In some embodiments, once one has the above test data, one may have the following test inputs: A SQL query; An expected result of converted query aggregation pipeline; a list of mappings that are relevant to the SQL query; and/or collections relevant to a certain test. These may be used as inputs for a test run as described below.

In some embodiments, once test data has been gathered based on the above, the test data can be included in the Test Runner as a JSON array file. The runner may take the list of mappings and an SQL query as inputs to the data request converter. The result of data request conversion may be a data request function that can be executed in a chosen language. On execution of the data request function may return some documents that can be compared against the expected documents that were generated previously. Comparing expected results for MongoDB documents may depend on ordering of documents returned that can affect equality checks. This may be mitigated by checking the length of the array returned as well as the contents of each individual document in some cases.

In some embodiments, the test runner may largely remain the same but the set of test data can be extended over time as more database queries are moved to this framework.

In some embodiments, stored procedures may be extracted from within and/or embedded into Java, C #and Javascript languages for conversion. In order to do this, separate language dependent repository projects may be set up where the converted query is included as a file in the selected language, which will be compiled together and executed for a test run.

In some embodiments, testing in multiple languages for both local and CI environments may be supported by placing these repositories inside a container (e.g., from Docker) so they can be compiled and run independently of the host environment. There may be pre-build containers based on language in ECR that can be used for this purpose.

In some embodiments, given a pre-build container as described above, the steps for every test may be: (1) Reset the container so it is in a clean state; (2) Take the output of step 1 in the Test Runner and insert into a file on the chosen language inside a docker container; (3) Compile the project and execute; and (4) Return the results back to the test runner. For instance, where the default language is JavaScript the JavaScript project may be used within the container for adhoc queries and views.

In some embodiments, the foregoing test framework may facilitate adding new datasets to test query conversion by simply adding a new relational database to the set of cases. As an initial dataset, one may add the development version of a dataset using the approach laid out above. The steps involved may include creating a live database connection from one of the existing databases that has several SQL queries and data. A relational to non-relational migration project may be created using the database with a recommended schema and with a 1:1 schema, then the data may be migrated to MongoDB. The SQL queries from the existing database in step 1 may be executed. The row/column outputs may be converted to JSON format as expected results from an MQL aggregation. Individual tests may be created for each of the SQL queries to which the output of the query conversion may be compared. The natural language question can become the test description.

In some embodiments, there may be tests that do not fit the above test framework such as the for detecting errors or when there is a particular shape of the data that is be asserted on. In this case one may stray from the above test framework and tests may be handcrafted test assert on a particular boundary condition or edge case. This may be useful for stored procedures that include CRUD operations, which use verifying by inspecting the current set of documents.

In some embodiments, improvements may be measured over time and statistics may be collected regularly. For example, PyTest has a terminal reporter that can be used to gather statistics on test runs. This can be used gather information such as: How long a test run took to finish; Which tests failed; and Which tests had retries before passing. Once this information is collected it can be sent to a MongoDB collection, for example, on every merge to main with the aim of building charts to plot changes on the overall query conversion to track performance and accuracy over time. Eventually, running the test suite periodically might also be worth consideration.

In some embodiments, a database migration desktop app may call Query converter lambda directly over the public internet. In other embodiments, the Query converted may be moved to Helix platform as a standalone HTTP service. By leveraging the Helix platform, monitoring, observability and alerting may be easily obtained.

In some embodiments, the Query Converter service may be exposed to the public internet as it may be called by the migration application which is running on the user's local machine. By default, the public facing APIs may time out in 30 seconds, though this can be changed. It may be better in some cases to not keep a connection open for a long period of time especially, when the connection will be idle most of the time to limit waste of server resources. The query conversion request to an LLM can take longer than 30 seconds. To improve latency, one may have two endpoints: (1) async API endpoint for client to submit the query conversion request; and (2) sync API endpoint that client polls to get the converted query.

In some embodiments, to support the asynchronous model, the converted query returned from AI may be stored temporarily and is returned the next time client polls. For instance, the converted query could be considered user data, one may store it in a MongoDB managed internal system. For that, one can use a MongoDB collection on Atlas.

For a MongoDB collection, one can set up a new MongoDB cluster, or reusing an existing cluster if one exists and is suitable for the purpose. In both cases, a new collection may be created with a document schema like shown below:

```
{
  _id: UUID,
  created: Date,
  status: “running|completed|failed”,
  query: “converted query”, // present only when status is completed
  failure: “convertion failure”, // present only when status is failed
}
```

In some cases, one may only plan to store the converted queries temporarily, and thus a TTL index may be created on the created field to have the documents deleted automatically after 1 day.

A POST/queries endpoint may be used by Migrator App to submit the initial query conversion request. Its body should be a JSON object containing information for conversion.

```
{
  language: “C#|Java|JavaScript”,
  sqlQuery: “SQL query”,
  mapping: { }, // mapping object
}
```

When a request comes in, the endpoint may: (1) Generate a new UUID; and (2) Insert a document to the collection; (3) Start a sub-process/thread that will send conversion request to an LLM; and (4) Return document from step 2 (e.g., without waiting for step 3 to finish).

```
{
  _id: “UUID from step 1”,
  created: Current Date,
  status: “running”,
}
```

In some embodiments, a data request conversion process will build the prompts and send them to the LLM to get the converted query. Once the result is returned, the process may update the corresponding MongoDB document with the converted query and its status as well.

```
{
  status: “completed”,
  query: “converted query”,
}
```

If an error occurred when converting the query, the process may update the corresponding MongoDB document with the failure information.

```
{
  status: “failed”,
  failure: “Failure message”
}
```

A GET/queries/{uuid} endpoint may be used by Migrator App for subsequent result polling after the initial POST request. This endpoint may use the UUID returned by the POST request described above. One may find the document with the UUID from the MongoDB collection and return the document. One can delete the document immediately after find so one doesn't hold the converted query longer than necessary, in some cases. Some drivers support findAndDelete that one can use.

A POST/queries/run endpoint may be used by a migration application to allow user tests running a converted query. The body of this request may be a JSON object as below and it will just forward the request to the language runner where the query actually runs. In some cases, this endpoint may be used with a Test Bench project.

```
{
  language: “C#|Java|JavaScript”,
  convertedFunction: “converted query function”,
  mongodb: “MongoDB connection string”,
}
```

In some embodiments, the data request conversion API may be designed to deploy in K8s using Helm charts. Preprocessing and dynamic rules embedding may be implemented for multi-stage and flexible design. Code migration and denormalization may be separately handled within the API. Context and instructions may be prompted modularly using separate system and user prompts. Asynchronously running conversation jobs may allow for higher level of concurrency and responsive UX.

Modernization of relational applications may be easily scaled both vertically and horizontally. The call to the LLM component may be dependent on the capacity and throttling specifications of the model. The API keys may be separated per user/user group or by deploying serverless models (e.g., to deploy and host the model).

Preprocessing logic can grow and get complex quickly as one tests more edge cases. In some cases, the preprocessing step may be reduced and also keep the logic as simple and maintainable as possible. Rules being added to the prompt can also grow as one presents more edge cases to the model.

In some cases, one may be making two calls to the LLM to first perform the conversion from SQL to MQL and then apply the mapping. This may result in high latency in some cases. One potential fix in that case could be to provide the result of both steps to the user. One could also consider using the streaming option to have a more responsive UX. In some cases, the model may tackle the task in one go.

In some cases, the input and output of the conversion, the execution result, the accuracy comparison result, user's changes to the code, and potentially user's rank and comment about the converted code may be saved for future reference unless a user opts out. In some embodiments, the introduction of the code runner in some implementations allows one to measure and capture this metric (e.g., 1=runs, 0=does not run). One should be able to measure the accuracy of the generated code. One good indicator of the accuracy is comparing the original query results versus the results of the generated code and checking whether the data is converted correctly or not (given the mapping). One can start with a boolean accuracy score, or one can expand it to be fuzzy as well (e.g. 0.0˜1.0). Also, one can ask users to explicitly provide a ranking score for the converted query (e.g 1˜5 stars).

In some embodiments, Generative AI and LLMs may be slow in nature given the sequential output generation of the Transformers architecture. Therefore the latency of the model used for code conversion may be an important metric to take into account. One should have an idea of how many concurrent requests one can serve based on the SLAs of the third party service provider or the deployment. Using these metrics, one can aim for improvements with more quantitative success criteria.

In some embodiments, one can capture the initial converted code (including the inputs and the output) for future reference and, as the user changes the code and re-runs it, one should capture the modified code which can also be used as the training data for a customised model (this is subject to the user or the organisation opting in to use their data for model optimisation).

In some cases, the execution result and also the data generated from the converted code may be as the implicit ground truth that can help us optimise the model in the future. Alternatively or additionally, one can also ask the users to rank the converted code and use that as the explicit ground truth signal (obviously in case they opt in and provide the optional feedback).

In some cases, one can calculate some insights and success metrics from the data that one captures and store. As an example one can find out that version 123.456 of the code has 65% executability and 75% accuracy on dataset D1. This may be a good way to benchmark improved versions against the previous ones.

In some cases, one may establish a framework that is able to answer questions like “What version of the model and what version of the prompt was used to generate code A? The results should be replicable using the right model and prompt version”, or “It looks like the accuracy of the results have degraded using model B that we rolled out recently. Can we do a side by side comparison with version A? Also, how do model A and B rank compared to all other experiments historically”. One can experiment with open source models (could mainly be found in Huggingface) especially those that are specialised in code analysis and code migration (e.g. CodeGen). Other, proprietary models that are made available by their authors in various platforms may be used. A good example is Amazon Bedrock which provides access to a variety of high quality proprietary models (e.g. Anthropic Claude v2).

In case there is an error in the execution of the code that the model has generated, one can provide the error to the model and ask it to improve its response. Third-party models like GPT and Gemini can also use this feedback to fine tune the model as well. In some cases, experimentation with model fine-tuning may use a relatively large dataset of inputs (SQL code and mapping) and outputs (the generated MQL code). One can further fine tune a model using the captured feedback via RLHF techniques.

One consideration for improving the accuracy of the query conversion is using more customised LLMs. These models have their pros and cons. Although there are loads of open source models available in platforms like Huggingface, third party models like GPT and Gemini are still state of the art in terms of the quality of the natural language and the code that they generate without any fine tuning. However, one may be able to customise a model that performs better on our specific code generation use cases. This may use a huge amount of training data. On the other hand, the development, deployment, and maintenance for a customised model should be taken into account when this approach is considered as an option.

In some cases, a process may be used for shaping a dataset that could be used for benchmarking and model training of the query converter. After conducting research on the existing datasets, this may provide guidelines for creating that dataset. In some cases, two datasets may be predominantly used: the benchmark dataset and the model fine-tuning dataset.

In the benchmarking dataset, one can have two subset of items in each instance of the dataset, the inputs and the ground truth. The input fields are the information that is presented to the model. The ground truth allows checking the correctness and the quality of the response retrieved from the model. It is also worth noting that there are two possible approaches for model evaluation. First is the black box approach, which assesses the results of the converted query. Second is the white box approach, which assesses the converted query itself

Based on these two approaches one may use different fields in the dataset which will be explained in more detail below.

For input in a relational database schema, one may have a list of predefined datasets that one wants to use for dataset creation. Each instance in the dataset may be linked to a certain dataset which has a certain schema. A schema can be represented in different ways, but the simplest way to think about it is a set of CREATE TABLE statements. A SQL query may be used for query conversion.

A relational to non-relational mapping may be input for the query conversion. For each database in use, one can have a list of mappings defined. Each instance in the dataset then can be linked to a certain mapping. A natural language description of the query may be included as an input in some cases. A SQL query dialect, such as MS SQL server or Oracle, may be specified in the input. One can also exclude this out and test the ability of the model to figure that out by itself. An MQL-embedding Language, such as Java, C #, Node.js may be specified in the input.3

For ground truth, one may have some implicit items for results. Although one may not provide the database data to the model, one can use relational database data for evaluation of the results (e.g., for black box approach). Alternatively or additionally MongoDB data may be used for evaluation of the model response (e.g., for black box approach). One may have a migrated version of the relational database, for example in MongoDB, which is ready to use. One may then use some explicit items which can be directly used as part of the evaluation process. The results of running the SQL query on the relational DB may be used in the black box evaluation approach. The Expected MQL results may be used (e.g., if one uses the black box evaluation approach) with direct SQL to MQL comparison. The Converted MQL query may be used, for example, with the white box evaluation approach.

In some embodiments, a fine tuning dataset may use a slightly different structure. Each training example may be in the form of a prompt with input, instruction and output sections. The input section may include the following information: (1) Relational DB schema; (2) SQL query; (3) Relational to MongoDB mapping; (4) SQL query dialect; (5) MQL Language. The output section may include the converted MQL query. It should be appreciated that the fine-tuning dataset could be generated from the benchmarking dataset. Therefore, one may create the benchmarking dataset, take a portion of it, reformat it and use that as the fine-tuning dataset.

In some cases, one may expect users to provide queries to the query converter that fall into one of several query categories, into which the following list of examples may be sorted. This list can be a good starting point that can be improved via input and the usage data analysis. It should be appreciated that most of the example queries may be written for the same test database. For each category, one or a few examples are added.

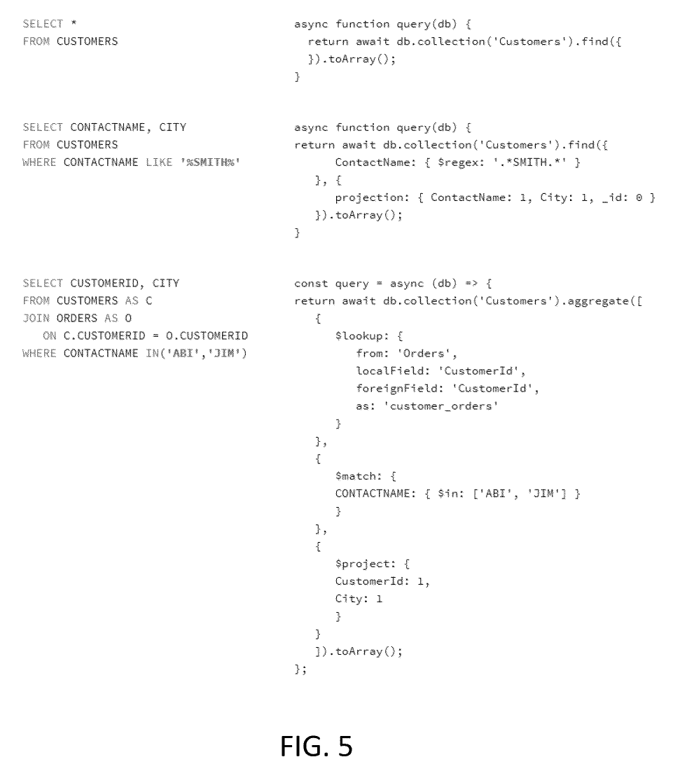

In addition to the examples listed below, FIG. 5 illustrates examples of data requests and converted data requests that may be obtained using processes described herein, according to some embodiments.

### Category 1—Simple SELECT Queries

| | | | |
|---|---|---|---|
| Query | | | Com- |
| description | SQL Query | Variations | ments |

| | | |
|---|---|---|
| Simple | select * | Different fields, |
| select | from customers | Aliases (tables |
| | | and fields), |
| | | distinct values, |
| | | select into |
| | | variables |
| Select with | select | Where with |
| where clause | invoice_number, | equality check, |
| | invoice_date | Where with |
| | from Invoices | inequality check, |
| | where | Where with in/not |
| | invoice_date>″202 | in, where with |
| | 3-12-01″ | between |
| Select with | select * | Order asc, desc, |
| order | from Customers | Order by multiple |
| | order by | fields |
| | customer_last_name | |
| | desc | |
| Date/time | SELECT * | date/time |
| manipulation | FROM Orders | comparison, |
| | WHERE | extract date/time |
| | year(date_order_placed | components |
| | )>2020 | |
| String | SELECT | Concatenation, |
| manipulation | *, | case change, |
| | customer_first_name+″ | substring, regular |
| | ″+customer_last_name | expressions |
| | as full_name | |
| | FROM Customers | |
| | WHERE | |
| | SUBSTRING(customer_las | |
| | t_name, 1, 1) = ″S″ | |
| Case | SELECT | |
| statement | *, | |
| | case when | |
| | gender=0 then ′male′ | |
| | else ′female′ end as | |
| | gender_desc | |
| | FROM Customers | |
| | LIMIT 10 | |

Category 2—SELECT Queries with JOINs

| | | | |
|---|---|---|---|
| Query | | | |
| description | SQL Query | Variations | Comments |

| | | |
|---|---|---|
| Simple join | SELECT | |
| | * | |
| | FROM Customers c | |
| | JOIN Orders o on | |
| | c.customer_id=o.customer | |
| | _id | |
| | ORDER BY | |
| | o.date_order_placed desc | |
| | LIMIT 10 | |
| Join on multiple | | |
| fields | | |
| Join on multiple | SELECT | |
| tables | c.customer_first_n | |
| | ame, | |
| | c.customer_last_name, | |
| | p.product_name | |
| | FROM Customers c | |
| | JOIN Orders o on | |
| | c.customer_id=o.customer | |
| | _id | |
| | JOIN Order_Items oi on | |
| | oi.order_id=o.order_id | |
| | JOIN Products p on | |
| | oi.product_id | |
| | =p.product_id | |
| | WHERE p.product_name | |
| | =′Coffee Bean′ | |
| | LIMIT 10 | |
| Join with where | SELECT | Add |
| clause | * | order by |
| | FROM Customers c | |
| | JOIN Orders o | |
| | WHERE | |
| | o.date_order_placed > | |
| | ′2010-01-01′ | |
| | LIMIT 10 | |
| Join with | | |
| aggregation | | |
| Other join types | Left and right outer joins, full | |
| | join | |
| Implicit join | SELECT | |
| (using where) | * | |
| | FROM Customers c, Orders | |
| | o | |
| | WHERE c.customer_id | |
| | =o.customer_id | |
| | LIMIT 10 | |
| Join on a shared | SELECT | |
| column | * | |
| | FROM Customers c | |
| | JOIN Orders o | |
| | LIMIT 10 | |
| Cross join | | |

Category 3—SELECT with Subqueries

In some cases, different types of subqueries may be used. Subqueries can also be used inside stored procedures.

| | | | |
|---|---|---|---|
| Query | | | |
| description | SQL Query | Variations | Comments |

| | |
|---|---|
| Scalar Subquery | SELECT name, |
| | listed_price |
| | FROM paintings |
| | WHERE listed_price > ( |
| | SELECT |
| | AVG(listed_price) |
| | FROM paintings |
| | ); |
| Multi-row | SELECT first_name, |
| subquery | last_name |
| | FROM collectors |
| | WHERE id IN ( |
| | SELECT collector_id |
| | FROM sales |
| | ); |
| Multi-row | SELECT |
| subquery with | artists. first_name, |
| multiple columns | artists.last_name, |
| | artist_sales.sales |
| | FROM artists |
| | JOIN ( |
| | SELECT artist_id, |
| | SUM(sales_price) AS |
| | sales |
| | FROM sales |
| | GROUP BY artist_id |
| | ) AS artist_sales |
| | ON artists.id = |
| | artist_sales.artist_id; |
| Correlated | SELECT |
| subquery | first_name, |
| | last_name, |
| | ( |
| | SELECT count (*) AS |
| | paintings |
| | FROM sales |
| | WHERE collectors.id |
| | = sales.collector_id |
| | ) |
| | FROM collectors; |
| Correlated | SELECT first_name, |
| subquery (other | last_name |
| example) | FROM artists |
| | WHERE NOT EXISTS ( |
| | SELECT * |
| | FROM sales |
| | WHERE sales.artist_id |
| | = artists.id |
| | ); |

Category 4—SELECT with Aggregations

| | | | |
|---|---|---|---|
| Query | | | |
| description | SQL Query | Variations | Comments |

| | | |
|---|---|---|
| | select count(*) from | All aggregation |
| | sales | types |
| Multiple | Select | |
| aggregations | min(date_ceated), | |
| | max(date_upaded) from | |
| | sales | |
| Aggregations | Select sales_id, | |
| with group by | count(sales_id) | |
| | From sales | |
| | Group by | |
| | month(creation_date) | |
| Aggregation with | | |
| having | | |

### Category 5—INSERT/UPDATE/DELETE

| | | | |
|---|---|---|---|
| Query | | | |
| description | SQL Query | Variations | Comments |

| | |
|---|---|
| Insert query | INSERT INTO Invoices |
| | (invoice_number, |
| | order_id, invoice_date) |
| | VALUES (1, 9, ′2018-03- |
| | 01 16:40:48′); |
| Batch insert | |
| query | |
| Update query | |
| Delete query | |

### Category 6—Stored Procedures, Read-Only

| | | | |
|---|---|---|---|
| Query description | SQL Query | Variations | Comments |

| | | |
|---|---|---|
| Simple stored proc | CREATE PROCEDURE | Different types of |
| | citycount (IN country | queries, variables |
| | CHAR (3), OUT cities | inside stored |
| | INT) | procedures |
| | BEGIN | |
| | SELECT | |
| | COUNT(*) INTO cities | |
| | FROM world.city | |
| | WHERE | |
| | CountryCode = | |
| | country; | |
| | END// | |
| Stored procedure | | |
| containing multiple | | |
| queries | | |
| Stored procedure | | |
| with no return value | | |
| Nested calls within | | |
| procedures | | |
| Cursors | CREATE PROCEDURE | |
| | curdemo( ) | |
| | BEGIN | |
| | DECLARE done INT | |
| | DEFAULT FALSE; | |
| | DECLARE a CHAR(16); | |
| | DECLARE b, c INT; | |
| | DECLARE cur1 CURSOR | |
| | FOR SELECT id, data | |
| | FROM test.t1; | |
| | DECLARE cur2 CURSOR | |
| | FOR SELECT i FROM | |
| | test.t2; | |
| | DECLARE CONTINUE | |
| | HANDLER FOR NOT FOUND | |
| | SET done = TRUE; | |
| | OPEN cur1; | |
| | OPEN cur2; | |
| | read_loop: LOOP | |
| | FETCH cur1 INTO | |
| | a, b; | |
| | FETCH cur2 INTO | |
| | c; | |
| | IF done THEN | |
| | LEAVE | |
| | read_loop; | |
| | END IF; | |
| | IF b < c THEN | |
| | INSERT INTO | |
| | test.t3 VALUES (a, b); | |
| | ELSE | |
| | INSERT INTO | |
| | test.t3 VALUES (a, c); | |
| | END IF; | |
| | END LOOP; | |
| | CLOSE cur1; | |
| | CLOSE cur2; | |
| | END; | |

### Category 7—Stored Procedures, Containing Write Operations

| | | | |
|---|---|---|---|
| Query description | SQL Query | Variations | Comments |

| | |
|---|---|
| Simple stored proc | DELIMITER $$ |
| with insert | DROP PROCEDURE IF |
| | EXISTS db.test $$ |
| | CREATE PROCEDURE |
| | db.test(IN id |
| | INT(12),IN NAME |
| | VARCHAR(255)) |
| | BEGIN |
| | INSERT INTO USER |
| | VALUES(id,NAME); |
| | END$$ |
| | DELIMITER; |
| Stored procedure | |
| with update | |
| Stored procedure | |
| with delete | |

### Category 8—Window Functions

| Query | | | |
|---|---|---|---|
| description | SQL Query | Variations | Comments |
| Standard window | with ranked_orderes | row_number, | Show the |
| function | as ( | rank | latest order |
| | select | | for each |
| | order_id, | | customer |
| | customer_id, | | |
| | rank( ) over | | |
| | (partition by | | |
| | customer_id order by | | |
| | date_order_placed) | | |
| | as rnk | | |
| | from Orders o | | |
| | order by customer_id | | |
| | ) | | |
| | select * | | |
| | from ranked_orderes | | |
| | where rnk =1 | | |
| Lead and lag | | | |
| operators | | | |

### Category 9—Common Table Expressions (CTEs)

| | | | |
|---|---|---|---|
| Query | | | |
| description | SQL Query | Variations | Comments |

| | |
|---|---|
| CTE on one | |
| table | |
| CTE with table | with female_customers as |
| joins | ( |
| | select * from |
| | Customers where |
| | gender=″female″ |
| | ) |
| | select * |
| | from Orders o |
| | join female_customers fc |
| | on o.customer_id = |
| | fc.customer_id |
| | where date_order_placed > |
| | ″202-01-01″ |
| CTE with more | |
| than two tables | |
| CTE with | |
| subquery | |
| CTE with | |
| window function | |

### Category 10—Set Operations

| | | | |
|---|---|---|---|
| Query description | SQL Query | Variations | Comments |

| | | |
|---|---|---|
| Union | | Union all |
| intersect | | |
| except | SELECT id, name, | |
| | department FROM | |
| | employees | |
| | EXCEPT | |
| | SELECT id, name, | |
| | department FROM | |
| | managers; | |

### Category 11—DDL Queries

| | | | |
|---|---|---|---|
| Query description | SQL Query | Variations | Comments |

| | | |
|---|---|---|
| Create table | CREATE TABLE | |
| | Invoices ( | |
| | invoice_number | |
| | INTEGER PRIMARY | |
| | KEY, | |
| | order_id INTEGER | |
| | NOT NULL, | |
| | invoice_date | |
| | DATETIME, | |
| | FOREIGN KEY | |
| | (order_id ) | |
| | REFERENCES | |
| | Orders(order_id | |
| | ) | |
| | ); | |
| Alter table | | |
| Create view | | |
| Alter view | | |
| Alter procedure | | |
| Create trigger | | |
| Alter trigger | | |
| Other DDL | | Create and alter |
| queries | | index, create |
| | | user, create role |

### Category 12—Handling Complex Types

| | | | |
|---|---|---|---|
| Query | | | Com- |
| description | SQL Query | Variations | ments |

| | | |
|---|---|---|
| Handling | SELECT | This may be dialect |
| json | * | specific, one should |
| | FROM | try this with different |
| | ‘e_store‘.‘ | dialects. The example |
| | products' | is specific to MySQL. |
| | WHERE | |
| | ‘category_i | |
| | d‘ = 1 | |
| | AND | |
| | JSON_EXTRACT(‘at | |
| | tributes‘ , | |
| | ′$.ports.usb′) > | |
| | 0 | |
| | AND | |
| | JSON_EXTRACT (‘at | |
| | tributes‘ , | |
| | ′$.ports.hdmi′) | |
| | > 0; | |
| Handling XML | | |
| Handling | | |
| custom types | | |

In some cases, one may also take into account different variations for the dataset mapping. Although there can be many permutations of these mappings, in general one may have the following mapping types for each database to be worked with: (1) one-to-one (table to collection); (2) embedded object (fields/documents in existing collection); and (3) embedded array (within existing collection).

One may consider the following variations as well when creating the dataset. First, coverage of all programming language in the dataset (Java, C #, Node.js as of now) for use with the migrated query language. Second, a variety of different source query language (e.g., SQL) dialects in the dataset (e.g., including Oracle, MySQL, PostgreSQL, Sybase). Also, dialect-specific queries such as execute statements in Oracle as shown below may be useful.

```
DECLARE
  TYPE ttConfig_record IS RECORD
      (name varchar2(255), value varchar2 (255));
    TYPE ttConfig_table IS TABLE OF ttConfig_record;
  v_ttConfigs ttConfig_table;
  BEGIN
    EXECUTE IMMEDIATE ‘CALL ttConfiguration’
    BULK COLLECT into v_ttConfigs;
    DBMS_OUTPUT.PUT_LINE (‘Name: ’ || v_ttConfigs(7).name
    || ‘ Value: ’ || v_ttConfigs(7).value);
  END;
  /
```

In some embodiments, generating a dataset may include setting the list of relational databases (including the schema and the data). A few mapping options for each dataset may be generated (e.g., using a database migration application). For each mapping, a migrated version in MongoDB may be generated (e.g., using the migration application). For each query category, variations of SQL dialect and MQL language(s) may be set. SQL queries may be generated and each instance may be stored, e.g., as a tuple of [NL description, SQL query, SQL dialect]. This could be done manually or synthetically using an LLM. The relational results against the relational DB may be retrieved, e.g., using some boilerplate tooling one may already have. The MongoDB results against the migrated DB may be generated (e.g., using the boilerplate tooling).

Optionally, depending on the evaluation approach, an MQL converted query may be generated for each SQL query generate for all possible MQL languages and all possible mappings. This may be done manually or via backtranslation approaches that allow synthetically generating the converted query). Also optionally, the expected MongoDB results may be generated, for example using some tooling.

It should be appreciated that queries that do not return a result set may be hard to evaluate in some cases, such as DDL queries, and write queries, though they may be addressed in other cases.

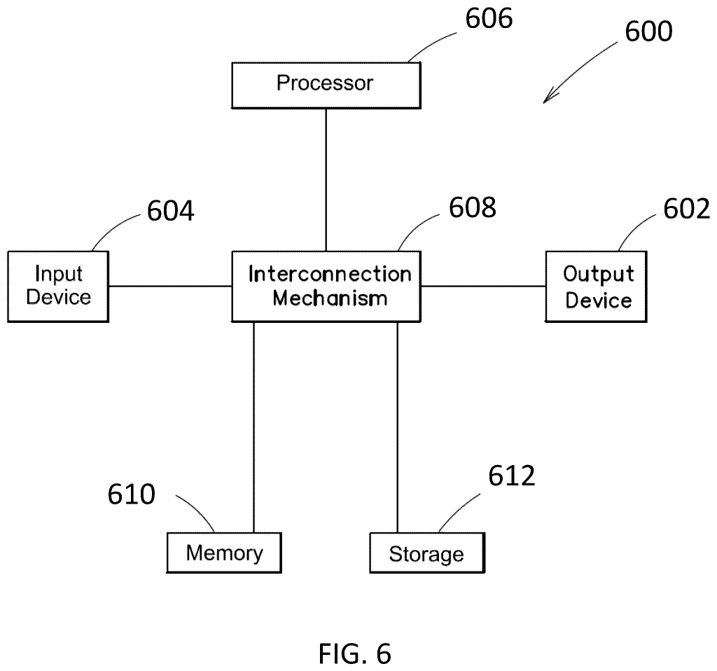

FIG. 6 illustrates a block diagram of an example special-purpose computer system 1300 on which various aspects of the present disclosure can be practiced, according to some embodiments. For example, computer system 600 may include a processor 606 connected to one or more memory devices 610, such as a disk drive, memory, or other device for storing data. Memory device(s) 610 is/are typically used for storing programs and data during operation of the computer system 600. Components of computer system 600 can be coupled by an interconnection mechanism 608, which may include one or more busses (e.g., between components that are integrated within a same machine) and/or a network (e.g., between components that reside on separate discrete machines). The interconnection mechanism enables communications (e.g., data, instructions) to be exchanged between system components of system 600.

Computer system 600 may also include one or more input/output (I/O) devices 602-604, for example, a keyboard, mouse, trackball, microphone, touch screen, a printing device, display screen, speaker, etc. Storage 612 typically includes a computer readable and writeable nonvolatile recording medium in which computer executable instructions are stored that define a program to be executed by the processor or information stored on or in the medium to be processed by the program.

The medium can, for example, be a disk or flash memory. Typically, in operation, the processor causes data to be read from the nonvolatile recording medium into another memory that allows for faster access to the information by the processor than does the medium. This other memory is typically a volatile, random-access memory such as a dynamic random-access memory (DRAM) or static memory (SRAM). According to one embodiment, the computer-readable medium comprises a non-transient storage medium on which computer executable instructions are retained.

Referring again to FIG. 6, the memory can be located in storage 612 as shown, or in a memory system. The processor 606 generally manipulates the data within the memory device(s) 610, and then copies the data to the medium associated with storage 612 after processing is completed. A variety of mechanisms are known for managing data movement between the medium and integrated circuit memory element and the present disclosure is not limited thereto. The present disclosure is not limited to a particular memory system or storage system.

The computer system may include specially-programmed, special-purpose hardware, for example, an application-specific integrated circuit (ASIC). Aspects of the present disclosure can be implemented in software, hardware or firmware, or any combination thereof. Although computer system 600 is shown by way of example, as one type of computer system upon which various aspects of the present disclosure can be practiced, it should be appreciated that aspects of the present disclosure are not limited to being implemented on the computer system as shown in FIG. 6. Various aspects of the present disclosure can be practiced on one or more computers having a different architectures or components than that shown in FIG. 6.

It should be appreciated that the present disclosure is not limited to executing on any particular system or group of systems. Also, it should be appreciated that the present disclosure is not limited to any particular distributed architecture, network, or communication protocol.

Various embodiments of the present disclosure can be programmed using an object-oriented programming language, such as Java, C++, Ada, or C #(C-Sharp). Other programming languages may also be used. Alternatively, functional, scripting, and/or logical programming languages can be used. Various aspects of the present disclosure can be implemented in a non-programmed environment (e.g., documents created in HTML, XML or other format that, when viewed in a window of a browser program, render aspects of a graphical-user interface (GUI) or perform other functions). The system libraries of the programming languages are incorporated herein by reference. Various aspects of the present disclosure can be implemented as programmed or non-programmed elements, or any combination thereof.

A distributed system according to various aspects may include one or more specially configured special-purpose computer systems distributed among a network such as, for example, the Internet. Such systems may cooperate to perform functions related to hosting a partitioned database, managing database metadata, monitoring distribution of database partitions, monitoring size of partitions, splitting partitions as necessary, migrating partitions as necessary, identifying sequentially keyed collections, optimizing migration, splitting, and rebalancing for collections with sequential keying architectures.

Having thus described several aspects and embodiments of this disclosure, it is to be appreciated that various alterations, modifications, and improvements will readily occur to those skilled in the art. Such alterations, modifications, and improvements are intended to be part of this disclosure and are intended to be within the spirit and scope of the present disclosure. Accordingly, the foregoing description is by way of example only.

As an alternative or in addition to migrating data from a relational database to a non-relational database, in some embodiments, transformation rules and other techniques described herein may be applicable in other forms of data migration, such as between non-relational databases having different schemas from one another. In some cases, techniques described herein may be useful in transforming data from a first logical arrangement to a second logical arrangement under the same schema, as embodiments described herein are not so limited.

As an alternative or in addition to data migration that may be performed at one time, in some embodiments, data migration may be performed continuously. For example, as a first database is updated, data from the first database may be transformed and stored in a second database according to a newly and/or previously specified transformation rule.

As an alternative or in addition to user specification of transformation rules, in some embodiments, selection of appropriate transformation rules may be at least partially automated. As one example, user specification of base groupings (e.g., tables) and/or links (e.g., primary keys) may be sufficient for automated transformation rules to designate which base-level data structures and/or groupings thereof are to transformed into new base-level data structures and/or fields within existing base-level data structures.

Use of ordinal terms such as “first,” “second,” “third,” “a,” “b,” “c,” etc., in the claims to modify or otherwise identify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of converting a data request for data under a first schema to a data request for a migrated version of the data under a second schema, the method comprising:
receiving a first data request targeting a subset of first data stored in a first database under a first schema, wherein second data stored in a second database under a second schema comprises a migrated version of the first data; and
converting the first data request into a second data request targeting a subset of the second data that comprises a migrated version of the subset of the first data, wherein the converting comprises:
pre-processing the first data request to obtain a modified first data request reflecting differences between the subset of the first data and the subset of the second data;
inputting the modified first data request into a large language model (LLM) to obtain, using a resulting output from the LLM, the second data request.

2. The method of claim 1, further comprising executing the second data request on the subset of the second data stored in the second database.

3. The method of claim 1, wherein the first data stored in the first database comprises relational data, the first data request comprises a query targeting a subset of the relational data, the second database comprises a flexible schema database, and the second data request targets unstructured data stored in the flexible schema database.

4. The method of claim 1, wherein the pre-processing further comprises removing fields from the first data request that are not used in the subset of the second data that is stored in the second database.

5. The method of claim 1, wherein the pre-processing further comprises extracting data operations in a query programming language from within data operations in a general-purpose programming language.

6. The method of claim 1, wherein the pre-processing further comprises identifying a largest data operation of the first data request, determining whether the largest data operation includes multiple query statements, and in response to determining that the largest data operation includes multiple query statements, separating and individually converting the multiple query statements to respective requests for corresponding data in the second database.

7. The method of claim 1, wherein the pre-processing further comprises converting the first data request from a first query programming language of the query to a second programming query language of the modified first data request.

8. The method of claim 7, wherein the first query language is a structured query language (SQL) and the second query language is MongoDB query language (MQL).

9. The method of claim 1, wherein the pre-processing further comprises performing a depth-first search in the modified first data request to verify representation of each data operation of the first data request in the modified first data request.

10. The method of claim 1, wherein the pre-processing further comprises replacing names of base data structures under the first schema in the subset of the first data with names of base data structures under the second schema in the second data that comprise the migrated version of the subset of the first data.

11. The method of claim 1, wherein:
the subset of the first data comprises a first grouping of base-level data structures and a second grouping of base-level data structures under the first schema stored in the first database;
the migrated version of the first data comprises a third grouping of base-level data structures under the second schema that comprises a migrated version of the first grouping and the second grouping; and
pre-processing the first data request comprises transforming a data operation in the first data request to join the first grouping with the second grouping into a data operation to access the third grouping.

12. The method of claim 11, wherein:
the first grouping of base-level data structures comprises a first table;
the second grouping of base-level data structures comprises a second table;
the third grouping of base-level data structures comprises a collection of documents; and
the collection comprises first documents corresponding to rows of the first table and further comprises second documents and/or fields in the first documents corresponding to rows of the second table.

13. The method of claim 11, wherein the third grouping comprises a set of base-level data structures corresponding to base-level data structures of the first grouping and further comprises at least one member selected from the group consisting of:
another set of base-level data structures corresponding to base-level data structures of the second grouping; and
fields within the set of base-level data structures corresponding to base-level data structures of the second grouping.

14. The method of claim 13, wherein:
the set of base-level data structures comprises documents corresponding to rows of a first table;
the another set of base-level data structures comprises documents corresponding to rows of a second table; and
the fields within the set of base-level data structures comprise fields within the documents corresponding to rows of the first table.

15. The method of claim 13, wherein the fields comprise an array within a base-level data structure of the set of base-level data structures.

16. The method of claim 15, wherein the array is within a document of the set of base-level data structures.

17. The method of claim 1, further comprising post-processing the output from the LLM to obtain the second data request in a query language corresponding to the second schema.

18. The method of claim 17, wherein the post-processing further comprises embedding data operations of the second data request within a general-purpose programming language.

19. The method of claim 17, wherein:
the pre-processing further comprises determining whether each grouping of base-level data structures in the subset of the first data corresponds to a respective grouping of base-level data structures in the subset of the second data, and
when a first grouping of base-level data structures in the subset of the first data does not correspond to a respective grouping of base-level data structures in the subset of the second data, the post-processing further comprises:
transforming a data operation accessing the respective grouping of base-level data structures in the subset of the second data into a transformed data operation accessing base-level data structures within another grouping of base-level data structures in the subset of the second data corresponding to another respective grouping of base-level data structures in the subset of the first data.

20. The method of claim 19, wherein the transformed data operation accesses an array within a base-level data structure in the another grouping in the subset of the second data, the array corresponding to the first grouping of base-level data structures in the subset of the first data.
